(19) United States
(12) Patent Application Publication
(10) Pub. No.: US 2025/0369649 A1
(43) Pub. Date: Dec. 4, 2025

(54) WATER HEATER

(71) Applicant: Cox Automotive, Inc., Atlanta, GA (US)

(72) Inventor: Connor Benjamin Taylor, Norman, OK (US)

(73) Assignee: Cox Automotive, Inc., Atlanta, GA (US)

(21) Appl. No.: 18/680,805

(22) Filed: May 31, 2024

(51) Int. Cl. F24H 9/14; F24H 15/37; H05B 1/02; H05B 3/42

(52) U.S. Cl. CPC F24H 9/14; F24H 15/37; H05B 1/0283; H05B 3/42; F24H 2240/01; H05B 2203/021

(57) ABSTRACT

A water heater is provided. The water heater includes a heating device having a metallic coil with an outer surface and an inner surface. The inner surface defines an inner channel between a first end and a second end of the metallic coil. Water enters the inner channel of the metallic coil from the first end of the metallic coil and is heated in the metallic coil. Heated water exits from the second end of the metallic coil. Water is not electrically isolated from the metallic coil. A first electrical connector is connected to the first end of the metallic coil. A second electrical connector is connected to the second end of the metallic coil. A controller connected to the heating device. The controller is configured to control heating of water.

### BACKGROUND

Environmental impact of non-renewable energy sources such as coal, petroleum, natural gas, and the like has led to an increased popularity of usage of green energy and recycling. Powering everyday devices, such as, electric vehicles and hybrid-electric vehicles, using electrochemical devices, for example, a rechargeable battery are some examples of green energy transaction. Powering devices using rechargeable batteries reduces carbon emissions and increases recycling efforts.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion. In addition, the drawings are illustrative as examples of embodiments of the invention and are not intended to be limiting.

FIG. 1 is a diagram of an operating environment for instant water heater.

FIG. 2 is a diagram illustrating battery modules of a battery.

FIG. 3 is a diagram illustrating sections of a battery.

FIG. 4 is a diagram illustrating a heating device.

FIG. 5 illustrates a cross-section of a metallic coil of the heating device of FIG. 4.

FIG. 6 is a flow diagram of the method for heating water.

FIG. 7 is a block diagram of a computing device.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Disclosure provides a water heater that can run on rechargeable batteries. A rechargeable battery (also referred to as a storage battery, a secondary cell, or an accumulator) is a type of electrical battery that can be charged, discharged into a load, and recharged many times. In addition, the disclosure provides a device for using remaining charge in batteries that are due for recycling to heat water. This solves the problem of dissipating the heat that is generated during discharge of batteries that are due for recycling. For instance, when rechargeable batteries are determined as degraded they may be recycled. Recycling includes crushing the batteries and extracting recyclable materials from the crushed mass. However, before crushing, the batteries need to be completely discharged. The batteries are discharged by connecting a load, for example, a resistor across its terminals. Implementations of the present disclosure provide a heating device that is connected across terminals of a battery for discharging the battery and heating water from the heat generated during discharging of the battery.

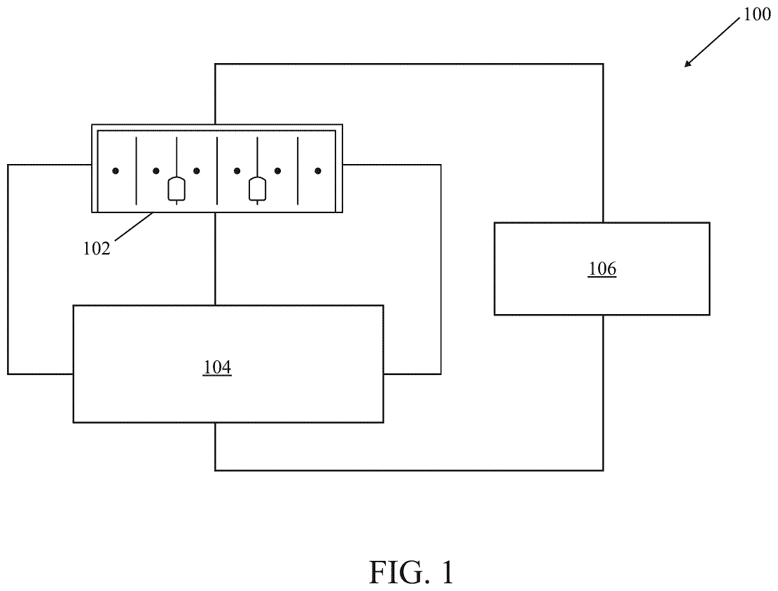

FIG. 1 is a block diagram of an operating environment 100 for an instant water heater. As shown in FIG. 1, operating environment 100 includes a battery 102, a heating device 104, and a controller 106. Battery 102 is connectable to heating device 104 and when connected discharges through heating device 104. Controller 106 monitors and controls heating of water through heating device 104. As discussed in greater detail in the following sections of the disclosure, heating device 104 utilizes the stored energy in battery 102 to heat water.

Battery 102 is an electrochemical device that stores energy for later consumption. Battery 102 may include a plurality of battery modules connected together. In examples, a battery module may be the smallest unit of battery 102 without breaking any permanent mechanical systems. In some implementation, these battery modules may be manufactured for or recovered from one or more batteries of a vehicle, for example, an electric vehicle.

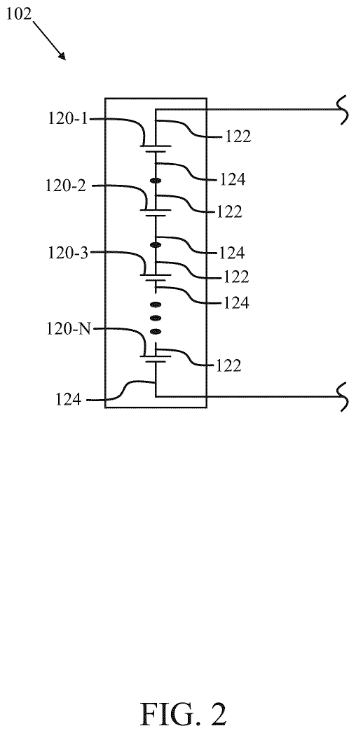

FIG. 2 illustrates an example battery 102. As shown in FIG. 2, battery 102 may include a plurality of battery modules, that is, a first battery module 120-1, a second battery module 120-2, a third battery module 120-3, . . . , an Nth battery module 120-N connected together. It may be understood that battery 102 may include any number of battery modules. For example, battery 102 may include 2, 3, 4, 5, 10, 20, 30, or 40, battery modules.

Each of the plurality of battery modules have a first battery module terminal 122 and a second battery module terminal 124. The plurality of battery modules can be combined in a series configuration in which first battery module terminal 122 of one of the plurality of battery modules is connected to second battery module terminal 124 of an adjacent battery module. In some arrangement, one or more battery modules are connected in parallel while some battery modules are connected in series. A total capacity and voltage rating of battery 102 may depend on a number of battery modules included in battery 102 and connection configuration of the battery modules.

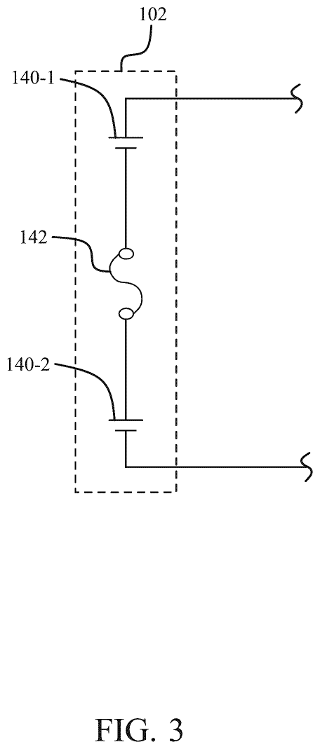

FIG. 3 is a diagram illustrating sections of battery 102. As shown in FIG. 3, battery 102 includes two sections, a first section 140-1 and a second section 140-2 connected by a fuse 142. Each of first section 140-1 and second section 140-2 may include multiple battery modules, for example, 2, 3, 4, 5, 10, 15, 20, 30, 40, etc. A number of battery modules in each of first section 140-1 and second section 140-2 may be same or different depending on a design consideration of battery 102. In addition, battery 102 may include more than two modules and the modules do not have to be separated by fuse 142. Moreover, in some examples, if present, fuse 142 does not have to be between sections, and can be located anywhere along a current path. For example, fuse 142 can be located anywhere on exterior of battery 102 so that fuse 142 is more accessible by a user.

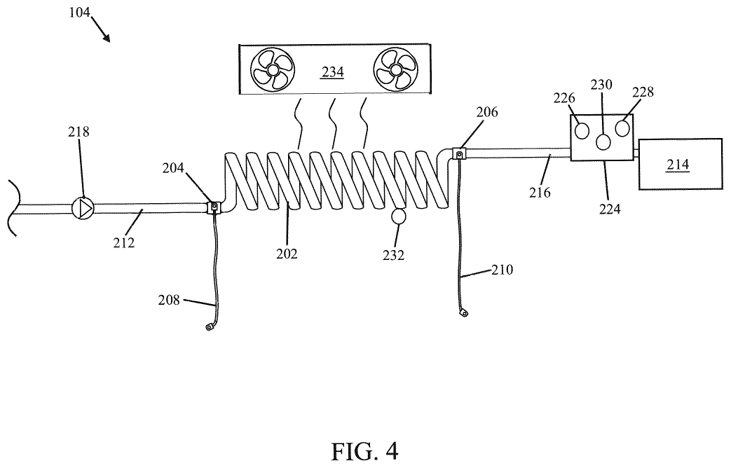

FIG. 4 is a diagram illustrating heating device 104. Heating device 104 is also referred to as a water heater. As shown in FIG. 4, heating device 104 includes a metallic coil 202 having a first end 204 and a second end 206. First end 204 of metallic coil 202 is associated with a first electrical connector 208 and second end 206 of metallic coil 202 is associated with a second electrical connector 210. First electrical connector 208 connects first end 204 of metallic coil 202 to a first terminal, for example, a positive terminal of battery 102. Second electrical connector 210 connects second end 206 of metallic coil 202 to a second terminal, for example, a negative terminal of battery 102.

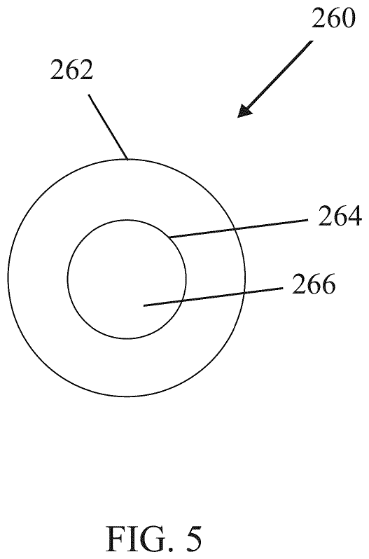

Metallic coil 202 further includes an inner channel. FIG. 5 is a diagram illustrating a cross section 260 of metallic coil 202. As shown in FIG. 5, metallic coil 202 includes an outer surface 262 and an inner surface 264. Inner surface 264 defines contours of an inner channel 266. Inner channel 266 extends between first end 204 and second end 206 of metallic coil 202.

Referring back to FIG. 4, first end 204 of metallic coil 202, and therefore, inner channel 266 is connectable to a water source through a first water connector 212. For example, a first end of first water connector 212 is connected to first end 204 of metallic coil 202. A second end of first water connector 212 is connectable to a water source. Second end 206 of metallic coil 202 is connectable to a storage tank 214 through a second water connector 216. For example, a first end of second water connector 216 is connected to second end 206 of metallic coil 202. A second end of second water connector 216 is connectable to storage tank 214. Storage tank 214 is configured to hold heated water.

A flow controller 218 may be provided to control flow of water from the water source to metallic coil 202 through first water connector 212. In some examples, flow controller 218 may be an electric pump or a controllable valve. Flow controller 218 may be controlled by controller 106 and may be powered through battery 102. In some implementations, flow controller 218 may be powered through an independent energy source and not battery 102. In another example embodiment, flow controller 218 may be located on the second water connector.

A sensing unit 224 is located between the second end of second water connector 216 and storage tank 214. Heated water exiting second end 206 of metallic coil 202 passes through sensing unit 224. Sensing unit 224 may include a plurality of sensors, for example, a flow sensor 226, a pressure sensor 228, and a water temperature sensor 230. The plurality of sensors of sensing unit 224 are configured to measure various aspects of water flow and send their respective measurements or determinations to controller 106.

Flow sensor 226, for example, may determine a continuity of the water flow through metallic coil 202. That is, flow sensor 226 may determine whether water is flowing through metallic coil 202 or the water flow has stopped. Flow sensor 226 therefore may also be referred to a flow continuity sensor. In addition, flow sensor 226 may determine a rate of flow of water through metallic coil 202.

In one example implementation, flow sensor 226 may be a hall effect sensor with a magnet. The magnet may be positioned within sensing unit 224 in a flow path of water flow. The magnet may move based on the level a rate of flow. When the rate of flow is below a threshold level, the magnet may drop from its current position. The hall effect sensor may detect a change in a magnetic field to determine disruption in the water flow.

Pressure sensor 228 may determine a water pressure and/or a gas pressure of heated water exiting metallic coil 202. Gas pressure may be present because of breaking down of water molecules. Water temperature sensor 230 may determine a temperature of the heated water exiting through second end 206 of metallic coil 202. Each of flow sensor 226, pressure sensor 228, and water temperature sensor 230 may send their respective determinations or measurements to controller 106.

Heating device 104 may further include a coil temperature sensor 232. Coil temperature sensor 232 may measure a temperature of metallic coil 202. In some implementations, coil temperature sensor 232 may be located on outer surface 262 of metallic coil 202 and may send the measured temperature to controller 106.

Heating device 104 may further include a heat management unit 234. Heat management unit 234 is configured to dissipate heat from metallic coil 202. In some implementations, heat management unit 234 may be a ventilation system with a fan that draws hot air from outer surface 262 of metallic coil 202. In other implementations, heat management unit 234 may be a fan that blows or circulates cool air on or around outer surface 262 of metallic coil 202. In example implementations, heating device 104 may include more than one metallic coil 202. In such implementations, more than one battery 102 can be discharged simultaneously using a single heating device 104.

In example implementations, metallic coil 202 is made from stainless steel. Stainless steel provides corrosion resistance from water. In addition, stainless steel has a higher resistance value per unit of length compared to other metals, such as, copper or aluminum. Therefore, metallic coil 202 when made of stainless steel provides a better resistance value for a same length compared to copper or aluminum. Moreover, it may be easier to manufacture or coil stainless steel into metallic coil 202 with inner channel 266. In addition, metallic coil 202 is self-supporting thereby obviating a need for a high temperature resistant stand that is also electrically insulated. In some examples, metallic coil 202 may be made from other metals or alloys with a relatively higher resistance value than stainless steel, for example, nichrome.

During operation (that is, water heating), first electrical connector 208 is connected to a first terminal (that is, positive or negative terminal) of battery 102. Second electrical connected 210 is connected to a second terminal (that is, negative or positive terminal) of battery 102. In some examples, each of first and second electrical connectors 208, 210 are connected to respective terminals of battery 102 through an electrical isolator that can be controlled by controller 106. When connected, current flows from battery 102 to metallic coil 202. Battery 102, thus, begins to discharge through metallic coil 202.

During discharging, the charge or energy stored in battery 102 is dissipated as heat in metallic coil 202. Water may flow from a water source into inner channel 266 of metallic coil 202. Water is not electrically isolated from metallic coil 202 and some current flows through water as well. In some implementations, water, by virtue of not being electrically isolated from the current path increases a resistance value of metallic coil 202 thereby increasing a discharge rate of battery 102.

In addition, by virtue of being in direct contact with metallic coil 202, the heat from metallic coil 202 is transferred to water thereby heating it. The heated water flows to storage tank 214. Controller 106 may monitor a state of charge of battery 102 as well as heating of water. Controller 106 may be an open loop controller or a closed loop controller. For example, controller 106 may receive various measurements from the plurality of sensors. Based on the received measurements, controller 106 may alter the discharging or flow rate of water. For example, in response to determining that the temperature of water exiting second end 206 of metallic coil 202 has reached a certain threshold level, controller 106 may discontinue, halt, or stop heating of water by breaking a flow of current from battery 102 to metallic coil 202. In another example, in response to determining that the state of charge on battery 102 has reached below a predefined threshold, controller 106 may provide an indication to a user that the charge in battery 102 is running low. In yet another example, in response to determining that the temperature of metallic coil 202 or heated water is above a pre-determined threshold, controller 106 may: disconnect heating device 104 from battery 102, increase a flow rate of water into metallic coil 202, and/or engage heat management unit 234. Heating device 104 can be disconnected from battery 102 by opening one or more connectors connecting battery 102 to heating device 104. The flow rate of water may be increased by sending signals to flow controller 218. Heat management unit 234 is engaged by sending signals to heat management unit 234 respectively.

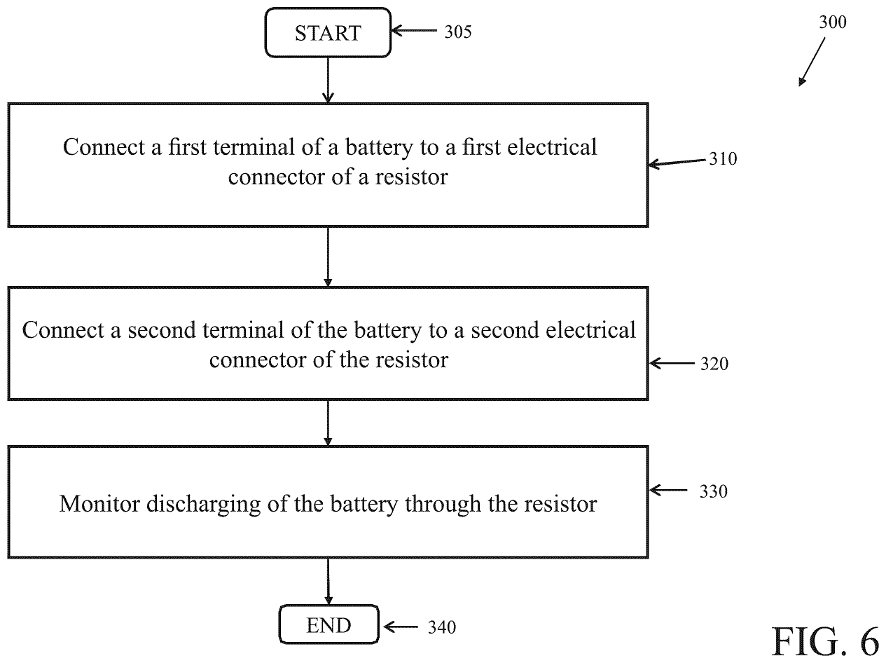

FIG. 6 is a flow chart setting forth the general stages involved in a method 300 consistent with an implementation of the disclosure for a method for recycling charge stored in battery 102. In some example, stages of method 300 may be performed by controller 106. Ways to implement the stages of method 300 will be described in greater detail below.

Method 300 begins at starting block 305 and proceeds to stage 310 where a first terminal of battery 102 is connected to first electrical connector 208 of heating device 104. In example implementations, the first terminal of battery 102 is connected to first electrical connector 208 via a connector that can be controlled by controller 106.

After connecting the first terminal of battery 102 to first electrical connector 208 of heating device 104 at stage 310, method 300 proceeds to stage 320 where a second terminal of battery 102 is connected to second electrical connector 210 of heating device 104. In example implementations, the second terminal of battery 102 is connected to second electrical connector 210 via a connector that can be controlled by controller 106. As discussed above, heating device 104 includes metallic coil 202 having first end 204 and second end 206. Metallic coil 202 includes inner channel 266 between first end 204 and second end 206. Water flows from first end 204 to second end 206 through inner channel 266 of metallic coil 202. Water is not electrically isolated from metallic coil 202. First electrical connector 208 is connected to first end 204 of metallic coil 202. Second electrical connector 210 is connected to second end 206 of metallic coil 202.

Once having connected the second terminal of battery 102 to second electrical connector 210 of heating device 104 at stage 320, method 300 proceeds to stage 330 where heating of water through heating device 104 is controlled. Controller 106, for example, may monitor operational parameters of the water heating. For example, controller 106 may monitor a state pf charge of battery 102, the temperature of metallic coil 202, the temperature of the heated water, a status of water flow, etc. Controller 106 determines if any of the operational parameters have exceeded a corresponding predetermined threshold. As discussed above, in response to determining that any of the operational parameters have exceeded the corresponding predetermined threshold, controller 106 may alter heating of water.

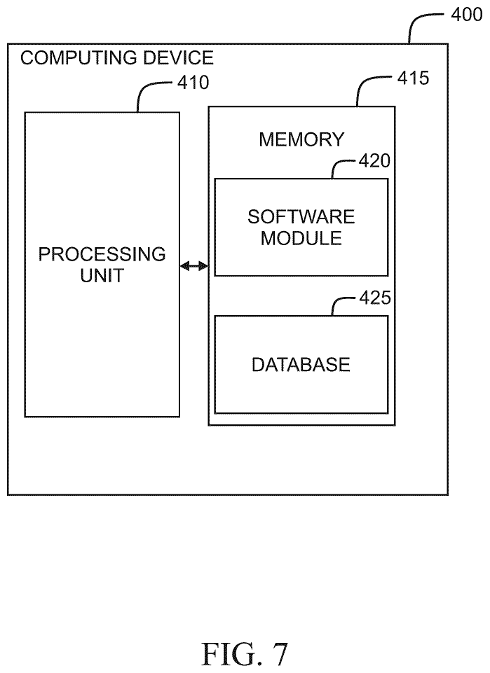

FIG. 7 shows computing device 400. As shown in FIG. 7, computing device 400 includes a processing unit 410 and a memory unit 415. Memory unit 415 includes a software module 420 and a database 425. While executing on processing unit 410, software module 420 performs, for example, processes for heating water using battery 102, including for example, any one or more of the stages from method 300 described above with respect to FIG. 6.

Computing device 400 can be implemented using a tablet device, a mobile device, a smart phone, a telephone, a remote control device, a personal computer, a network computer, a mainframe, a router, a switch, a server cluster, a smart TV-like device, a network storage device, a network relay device, or other similar microcomputer-based device. Computing device 400 can include any computer operating environment, such as hand-held devices, multiprocessor systems, microprocessor-based or programmable sender electronic devices, minicomputers, mainframe computers, and the like. Computing device 400 can also be practiced in distributed computing environments where tasks are performed by remote processing devices. The aforementioned systems and devices are examples and computing device 400 can comprise other systems or devices.

Embodiments of the disclosure, for example, can be implemented as a computer process (method), a computing system, or as an article of manufacture, such as a computer program product or computer readable media. The computer program product can be a computer storage media readable by a computer system and encoding a computer program of instructions for executing a computer process. The computer program product can also be a propagated signal on a carrier readable by a computing system and encoding a computer program of instructions for executing a computer process. Accordingly, the present disclosure can be embodied in hardware and/or in software (including firmware, resident software, micro-code, etc.). In other words, embodiments of the present disclosure can take the form of a computer program product on a computer-usable or computer-readable storage medium having computer-usable or computer-readable program code embodied in the medium for use by or in connection with an instruction execution system. A computer-usable or computer-readable medium can be any medium that can contain, store, communicate, propagate, or transport the program for use by or in connection with the instruction execution system, apparatus, or device.

The computer-usable or computer-readable medium can be, for example but not limited to, an electronic, magnetic, optical, electromagnetic, infrared, or semiconductor system, apparatus, device, or propagation medium. More specific computer-readable medium examples (a non-exhaustive list), the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general-purpose computer or in any other circuits or systems.

Embodiments of the disclosure may be practiced via a system-on-a-chip (SOC) where each or many of the element illustrated in FIGS. 1-3 and 5 may be integrated onto a single integrated circuit. Such a SOC device may include one or more processing units, graphics units, communications units, system virtualization units and various application functionality all of which may be integrated (or “burned”) onto the chip substrate as a single integrated circuit. When operating via a SOC, the functionality described herein with respect to embodiments of the disclosure, may be performed via application-specific logic integrated with other components of computing device 400 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A water heater, comprising:
a heating device comprising:
a metallic coil having an outer surface and an inner surface, the inner surface defining an inner channel between a first end and a second end of the metallic coil, wherein water enters the inner channel of the metallic coil from the first end of the metallic coil and is heated in the metallic coil, wherein heated water exits from the second end of the metallic coil, and wherein water is not electrically isolated from the metallic coil;
a first electrical connector connected to the first end of the metallic coil;
a second electrical connector connected to the second end of the metallic coil; and
a controller connected to the heating device, wherein the controller is configured to control heating of water.

2. The water heater of claim 1, wherein the first end of the metallic coil is connected to a water source.

3. The water heater of claim 1, whereon the second end of the metallic coil is connected to a storage tank configured to store the heated water.

4. The water heater of claim 1, wherein the water heater is powered using a battery.

5. The water heater of claim 4, wherein the battery is a rechargeable battery recovered from an electric vehicle.

6. The water heater of claim 1, wherein the heating device further comprises a coil temperature sensor configured to determine a temperature of the outer surface of the metallic coil.

7. The water heater of claim 1, wherein the heating device further comprises a water temperature sensor configured to determine a temperature of the heated water exiting the second end of the metallic coil.

8. The water heater of claim 1, wherein the heating device further comprises a flow controller configured to control a rate of flow of water into the inner channel of the metallic coil based on a temperature of the heated water exiting the second end of the metallic coil.

9. A battery powered water heater comprising:
a heating device comprising:
a metallic coil having a first end and a second end, wherein the metallic coil comprises an inner channel between the first end and the second end;
a first electrical connector connected to the first end of the metallic coil, wherein the first electrical connector is connectable to a first terminal of a battery;
a second electrical connector connected to the second end of the metallic coil, wherein the second electrical connector is connectable to a second terminal of the battery; and
wherein water flows from the first end to the second end through the inner channel of the metallic coil and is heated in the metallic coil, wherein heated water exits from the second end of the metallic coil, and wherein water is not electrically isolated from the metallic coil; and
a controller connected to the heating, wherein the controller is configured to control heating of water.

10. The battery powered water heater of claim 9, further comprising:
a flow controller configured to control a rate of flow of water into the inner channel of the metallic coil based on a temperature of the heated water exiting the second end of the metallic coil.

11. The battery powered water heater of claim 9, wherein the controller is configured to disconnect the battery from the heating device in response to determining that a temperature of the heated water is above a predetermined threshold.

12. The battery powered water heater of claim 9, wherein the battery is a rechargeable battery recovered from an electric vehicle.

13. The battery powered water heater of claim 9, further comprising:
a sensing unit connected to the second end of the metallic coil, wherein the sensing unit comprises one or more of: a flow sensor, a pressure sensor, and a water temperature sensor.

14. The battery powered water heater of claim 13, wherein:
the flow sensor is configured to measure a rate of flow of water through the metallic coil;
the water temperature sensor is configured to measure a temperature of the heated water.

15. The battery powered water heater of claim 14, wherein the controller is configured to:
receive the rate of flow of water and the temperature of the heated water; and
alter heating of water based on the continuity of flow of the water and the temperature of the heated water.

16. The battery powered water heater of claim 14, wherein the controller is configured to:
receive a temperature of the metallic coil from a coil temperature sensor; and
alter heating of water based on the temperature of the metallic coil.

17. A method of recycling charge stored in a battery, the method comprising:
connecting a first terminal of a battery to a first electrical connector of a heating device;
connecting a second terminal of the battery to a second electrical connector of the heating device, wherein the heating device comprises:
a metallic coil having a first end and a second end, wherein the metallic coil comprises an inner channel between the first end and the second end, wherein water flows from the first end to the second end through the inner channel of the metallic coil, and wherein water is not electrically isolated from the metallic coil;
the first electrical connector connected to the first end of the metallic coil; and
the second electrical connector connected to the second end of the metallic coil; and
controlling heating of the water through the heating device.

18. The method of claim 17, further comprising:
controlling the heating of water based on a temperature of the metallic coil and a temperature of the heated water.

19. The method of claim 17, further comprising controlling a rate of flow of water based on a temperature of the metallic coil and a temperature of the heated water.

20. The method of claim 17, wherein the battery is recovered from an electric vehicle.
